(19) United States
(12) Patent Application Publication
(10) Pub. No.: US 2025/0127667 A1
(43) Pub. Date: Apr. 24, 2025

(54) APPARATUS AND METHODS FOR MODIFYING A BATTERY ELECTRIC VEHICLE FOR WHEELCHAIR ACCESS

(71) Applicant: The Braun Corporation, Winamac, IN (US)

(72) Inventors: Michael Pugh, Carmel, IN (US); Eric Sajed Dosenbach, Indianapolis, IN (US)

(21) Appl. No.: 18/911,311

(22) Filed: Oct. 10, 2024

Related U.S. Application Data
(60) Provisional application No. 63/591,642, filed on Oct. 19, 2023.

(51) Int. Cl. A61G 3/06; B60G 17/017; B60L 50/60; B60Q 9/00; H01M 50/242; H01M 50/249

(52) U.S. Cl. CPC A61G 3/061; B60L 50/66; B60Q 9/008; H01M 50/242; H01M 50/249; B60G 17/017; H01M 2220/20

(57) ABSTRACT

To provide access to individuals having mobility disabilities, an OEM battery electric vehicle may be modified to include one or more of a wheelchair ramp, a lowered floor, a lowered battery, an adjustable suspension, and supplemental impact protection. The adjustable suspension of the modified vehicle may be operated to position the body of the vehicle alternatively between a lowered position and a raised position. In the lowered position, at least one of the ramp angle and length may be reduced relative to a comparable ramp in the OEM vehicle. In the raised position, the vehicle ground clearance may be slightly less than, approximately equal to or greater than the ground clearance of the OEM vehicle at GVWR.

### CROSS-REFERENCE TO OTHER APPLICATIONS

This application claims priority to U.S. Provisional Patent Application No. 63/591,642, filed 19 Oct. 2023, the contents of which are incorporated herein by reference. This application also incorporates by reference PCT Application No. PCT/US24/50619, filed 10 Oct. 2024.

### FIELD OF THE DISCLOSURE

The present disclosure relates generally to a battery electric vehicle (for example a passenger, crew, cut away, delivery, or cargo vehicle) that has been modified to allow access by a passenger with physical, cognitive, or other limitations.

### BACKGROUND

Automobile manufacturers (“OEM”) do not currently mass-produce vehicles specifically designed to transport persons having physical, cognitive, or other limitations, either as a driver or a passenger. Consequently, mass-produced vehicles (referred to herein as an “OEM vehicle”) having internal combustion engines (“ICE”), including hybrid vehicles, are altered, modified, re-manufactured and/or retrofitted to make what is inclusively referred to herein as a “modified vehicle”, by aftermarket companies (e.g., alterers and modifiers) dedicated to supplying vehicles for such persons.

ICE vehicles are modified by removing certain parts or structures within a vehicle and/or installing parts specifically designed to accommodate persons with limitations. In one configuration, an ICE vehicle may be retrofitted with a ramp to enable an individual using a wheelchair to enter the vehicle without the assistance of another individual. Once inside the vehicle, such individuals may operate the vehicle as a vehicle operator or occupy locations designated for passengers. This may include, but is not limited to, front-passenger, mid-passenger, and/or rear-passenger locations.

For the safety of the wheelchair passenger, the Americans with Disabilities Act (ADA) requires a ramp slope of no more than 1:4 (1 inch of vertical rise to 4 inches of ramp length, which equates to an angle of approximately 14.5° with respect to horizontal). However, for the comfort of the wheelchair passenger, a ramp angle of roughly 10.5° or less with respect to horizontal is preferred. Geometry dictates that the ramp angle can be reduced for a given vehicle by lowering the floor of the vehicle and/or increasing the length of the ramp platform. As a practical matter, the extent to which a ramp platform can be lengthened is limited, for example, by the width and/or interior space of the vehicle and/or the width of access aisles (the “crosshatch” area) next to accessible parking spaces and/or considerations of practical application and use.

Therefore, to achieve mandated or desired ramp slopes/angles, ICE vehicles usually require modification to lower the floor. Typically, at least a portion of the OEM floor will be removed and replaced with a new, lower floor (sometimes referred to as a floor weldment or floor structure). Viable candidates for a lowered-floor modification are front wheel drive ICE vehicles (including hybrid vehicles)—i.e., vehicles lacking under-floor mechanicals that cannot be easily rerouted, moved, or lowered with the new floor, such as a vehicle driveshaft. An above-floor ramp may be installed on top of the new floor surface of the floor weldment, or the floor weldment may include a recessed area or other pocket for receiving an in-floor/under-floor ramp whereby the top cover of the in-floor ramp may be approximately flush with the new floor surface of the floor weldment.

Accordingly, lowered-floor, ICE wheelchair accessible vehicles that achieve optimal ramp angles are known in the prior art. The same cannot be said for battery electric vehicles (“BEV”), which have high voltage batteries located below the vehicle floor surface. BEVs have not been considered viable candidates for lowered-floor modification partly because high voltage batteries cannot be easily moved or lowered with a new lowered floor. Indeed, BEV batteries are much more sensitive to damage from road debris than typical under-floor mechanicals on an ICE vehicle, such as exhaust pipes, and are orders of magnitudes more expensive to replace should damage occur. Moreover, BEV batteries (as contrasted to plug-in hybrid electric vehicle batteries) are large, occupying a footprint nearly equal to the entire floor between the vehicle's front and rear wheels—both side-to-side and front-to-back. BEV batteries are also very thick, which limits the extent to which the vehicle floor can be lowered. Accordingly, there is a need in the art for apparatus and methods for modifying an OEM BEV to create a wheelchair accessible BEV with optimal, or at least acceptable, ramp angles and/or to protect BEV batteries that have been lowered from their OEM position. There is also a need in the art for methods of using such a wheelchair accessible BEV to obtain optimal or acceptable ramp angles during ingress and egress while also maintaining optimal or acceptable ground clearance for the high voltage battery during transit.

### SUMMARY OF THE EMBODIMENTS

The present disclosure addresses these shortcomings of the prior art.

In one embodiment, a method for modifying a battery electric vehicle from an OEM condition into a modified condition is provided. In the OEM condition, the battery electric vehicle has an original high voltage battery assembly with at least one of an original ground clearance and an original ramp over angle. The method comprising the step of installing a high voltage battery assembly at a lower elevation than the original high voltage battery assembly relative to a body of the battery electric vehicle. The method also comprises the step of configuring a height adjustment device to move at least a portion of the body of the battery electric vehicle between a lowered position and a raised position. In the raised position, the high voltage battery assembly has at least one of a modified ground clearance and a modified ramp over angle. Additionally, the modified ground clearance is slightly less than, approximately equal to, or greater than the original ground clearance. In some embodiments, the modified ground clearance may be within 1″ or 2″ less than the original ground clearance. In alternative embodiments, the modified ramp over angle is slightly less than, approximately equal to, or greater than the original ramp over angle.

The original ground clearance and the original ramp over angle may be defined when the battery electric vehicle is at an original GVWR. In alternative embodiments, the original ground clearance and the original ramp over angle may be defined when the battery electric vehicle is somewhere between an original GVWR and an original curb weight. In yet another embodiment, the original ground clearance and the original ramp over angle may be defined when the battery electric vehicle is at an original curb weight. In alternative embodiments, the modified ground clearance and the modified ramp over angle may be defined when at least one axle of the battery electric vehicle is at an original GAWR.

The modified ground clearance and the modified ramp over angle may be defined when the battery electric vehicle is at a modified GVWR. In alternative embodiments, the modified ground clearance and the modified ramp over angle may be defined when at least one axle of the battery electric vehicle is at a modified GAWR. The modified GVWR and modified GAWR may be less than the original GVWR and original GAWR respectively.

The original GVWR may be approximately the same as the modified GVWR. The original GAWR may be approximately the same as the modified GAWR.

The original ground clearance and the modified ground clearance may be defined by the distance between a lower plane of the original high voltage battery assembly and a ground.

The original ground clearance and the modified ground clearance may be defined at a front end of the original high voltage battery assembly and the high voltage battery assembly.

The original ground clearance and the modified ground clearance may be defined at a middle of the original high voltage battery assembly and the high voltage battery assembly.

The original ground clearance and the modified ground clearance may be defined at a rear end of the original high voltage battery assembly and the high voltage battery assembly.

The method may include the step of providing a ramp platform moveable between a stowed position and a deployed position, wherein in the deployed position the ramp bridges a gap between a floor surface of the battery electric vehicle and a ground.

The ramp platform may have a slope equal to or less than approximately 1:4 when the body of the battery electric vehicle is in the lowered position.

The ramp platform may have an angle equal to or less than approximately 13° relative to the ground when the body of the battery electric vehicle is in the lowered position.

The ramp platform may have an angle equal to or less than approximately 12° relative to the ground when the body of the battery electric vehicle is in the lowered position.

The ramp platform may have an angle equal to or less than approximately 11° relative to the ground when the body of the battery electric vehicle is in in the lowered position.

The ramp platform may have an angle equal to or less than approximately 10.5° relative to the ground when the body of the battery electric vehicle is in the lowered position.

The ramp platform may have an angle equal to or less than approximately 10° relative to the ground when the body of the battery electric vehicle is in the lowered position.

The battery electric vehicle may lack an internal combustion engine or may be a hybrid vehicle with an internal combustion engine.

The original and modified high voltage battery assemblies may substantially occupy an area from a front axle to a rear axle and from a right vehicle side to a left vehicle side.

The method may include the step of lowering a floor of the battery electric vehicle relative to the body.

Lowering the floor may involves removing at least a portion of an OEM floor structure and installing a modified floor structure. The modified floor structure may be a replacement floor structure or may be an modification of and incorporate at least a portion of the OEM floor structure that was removed from the battery electric vehicle.

A thickness of the modified floor structure may be less than a thickness of the OEM floor structure.

A floor surface of the modified floor structure may be substantially flat.

The OEM floor structure may include an original bolting pattern for supporting the original high voltage battery assembly at an original elevation. The modified floor structure may include a modified bolting pattern being substantially the same as the original bolting pattern whereby the modified floor structure can support the high voltage battery assembly at the lower elevation.

In the OEM condition, an original gap may exist between the OEM floor structure and the original high voltage battery assembly. In the modified condition, a thickness of a modified gap between the modified floor structure and the high voltage battery assembly may be reduced relative to the original gap.

The method may include the steps of removing the original high voltage battery assembly from the battery electric vehicle and reinstalling the original high voltage battery assembly on the battery electric vehicle at the lower elevation, wherein the high voltage battery assembly may be the original high voltage battery assembly.

The original high voltage battery assembly may be modified before reinstalling at the lower elevation.

The method may include the step of removing the high voltage battery assembly from a different battery electric vehicle before installing the high voltage battery assembly at the lower elevation on the battery electric vehicle, wherein the high voltage battery assembly may not be the original high voltage battery assembly.

The method may include the step of lowering a crush zone member for the modified high voltage battery assembly. In alternative embodiments, the method may include the step of extending the crush zone member for the modified high voltage battery assembly.

The method may include the step of installing a side-impact structure (or bumper) at a side of the modified high voltage battery assembly.

The side-impact structure may be a rocker panel extension.

The side-impact structure may be a running board.

The method may include the step of removing at least a portion of an OEM rocker panel, wherein the portion of the OEM rocker panel is the side-impact structure. In alternative embodiments, the method may include the step of extending at least a portion of an OEM rocker panel.

The side-impact structure may be configured such that an impact load bypasses the high voltage battery assembly.

The method may include the step of installing a front-impact structure (or bumper) forward of the modified high voltage battery assembly.

The front-impact structure may be a deflection device, such as a cow catcher, configured to deflect road debris away from the modified high voltage battery assembly.

The front-impact structure may be configured such that an impact load bypasses the high voltage battery assembly.

The method may include the step of installing an underside-impact structure (or bumper) below the modified high voltage battery assembly.

The underside-impact structure may be a bash plate.

The underside-impact structure may be configured such that an impact load bypasses the high voltage battery assembly.

The height adjustment device may include an airbag that is inflated to move the vehicle to the raised position and deflated to move the vehicle to the lowered position.

The height adjustment device may include a tire that is inflated to move the vehicle to the raised position and deflated to move the vehicle to the lowered position.

In the lowered position, an underside of the battery electric vehicle may touch or approximately touch (be closely spaced from) a ground.

In another embodiment, a battery electric vehicle may be provided. The vehicle may include a high voltage battery assembly disposed below a vehicle floor. In an OEM condition at an OEM GVWR, the high voltage battery assembly has at least one of an original ground clearance and an original ramp over angle. The vehicle may include a ramp platform moveable between a stowed position and a deployed position. In the deployed position, the ramp may bridge a gap between a surface of the vehicle floor and a ground. The vehicle may include a height adjustment device configured to move at least a portion of a body of the battery electric vehicle between a lowered position and a raised position. In the raised position, the high voltage battery assembly may have a ground clearance that may be slightly less than, approximately equal to or greater than the original ground clearance. Additionally or alternatively, the high voltage battery assembly may have a ramp over angle that may be slightly less than, approximately equal to or greater than the original ramp over angle.

At least one of the ground clearance and the ramp over angle may be defined when the battery electric vehicle is at a modified GVWR.

The OEM GVWR may be approximately the same as the modified GVWR.

The original ground clearance and the ground clearance may be defined by the distance between a lower plane of the high voltage battery assembly and a ground.

The original ground clearance and the ground clearance may be defined at a front end of the high voltage battery assembly.

The original ground clearance and the ground clearance may be defined at a middle of the high voltage battery assembly.

The original ground clearance and the ground clearance modified defined at a rear end of the high voltage battery assembly.

The ramp platform may have a slope equal to or less than approximately 1:4 when the body of the battery electric vehicle is in the lowered position.

The ramp platform may have an angle equal to or less than approximately 13° relative to the ground when the body of the battery electric vehicle is in the lowered position.

The ramp platform may have an angle equal to or less than approximately 12° relative to the ground when the body of the battery electric vehicle is in the lowered position.

The ramp platform may have an angle equal to or less than approximately 11° relative to the ground when the body of the battery electric vehicle is in in the lowered position.

The ramp platform may have an angle equal to or less than approximately 10.5° relative to the ground when the body of the battery electric vehicle is in the lowered position.

The ramp platform may have an angle equal to or less than approximately 10° relative to the ground when the body of the battery electric vehicle is in the lowered position.

The battery electric vehicle may lack an internal combustion engine or may be a hybrid vehicle with an internal combustion engine.

The high voltage battery assembly may substantially occupy an area from a front axle to a rear axle and from a right vehicle side to a left vehicle side.

The floor may be lowered relative to a floor of the battery electric vehicle in the OEM condition.

The high voltage battery assembly may be disposed at a lower elevation relative to an original elevation in an OEM condition.

At least a portion of an OEM floor structure may have been replaced by a modified floor structure.

A thickness of the modified floor structure may be less than a thickness of the OEM floor structure.

A floor surface of the modified floor structure may be substantially flat.

The OEM floor structure may include an original bolting pattern for supporting the original high voltage battery assembly at an original elevation. The modified floor structure may include a modified bolting pattern that may be substantially the same as the original bolting pattern whereby the modified floor structure supports the high voltage battery assembly at a lower elevation relative to the original elevation.

In the OEM condition, an original gap may exist between the OEM floor structure and the original high voltage battery assembly and in the modified condition a thickness of a modified gap between the modified floor structure and the high voltage battery assembly is reduced (including being eliminated altogether) relative to the original gap.

A front-impact structure may be disposed forward of the high voltage battery assembly.

The front-impact structure may be a cow catcher configured to deflect road debris away from the high voltage battery assembly.

The front-impact structure may be configured such that an impact load bypasses the high voltage battery assembly.

An underside-impact structure may be disposed below the high voltage battery assembly.

The underside-impact structure may be a bash plate.

The underside-impact structure may be configured such that an impact load bypasses the high voltage battery assembly.

The height adjustment device may include an airbag that is inflated to move the vehicle to the raised position and deflated to move the vehicle to the lowered position.

The height adjustment device may include a tire that is inflated to move the vehicle to the raised position and deflated to move the vehicle to the lowered position.

In the lowered position, an underside of the battery electric vehicle touches or approximately touches (i.e., closely spaced from) a ground.

In another embodiment, a method of operating a battery electric vehicle is provided. The battery electric vehicle may be any of the previously recited battery electric vehicles or result from performing any of the previously recited methods for modifying such a vehicle. The method may include, at a first location, moving the battery electric vehicle to the lowered position, deploying the ramp whereby a wheelchair may enter the battery electric vehicle, stowing the ramp, and moving the battery electric vehicle to the raised position. The method may include transporting the wheelchair to a second location.

The method may include the step of, at the second location, moving the battery electric vehicle to the lowered position, deploying the ramp whereby the wheelchair may exit the battery electric vehicle, stowing the ramp, and moving the battery electric vehicle to the raised position.

The method may include the step of sensing whether an obstruction is present under the battery electric vehicle and preventing the battery electric vehicle from moving to the lowered position if an obstruction is present.

The method may include the step of sensing whether an obstruction is present under the battery electric vehicle and generating an alert if an obstruction is present.

The method may include the step of moving the vehicle to a different location if an obstruction is present.

In yet another embodiment, a system for kneeling a vehicle is provided. The system may include one or more processors. A height adjustment device may be configured to move at least a portion of a body of the vehicle from a raised position to a lowered position. One or more perception sensors may be configured to perceive an area underneath the vehicle. A non-transitory computer-readable medium coupled to the one or more processors may include instructions, which when executed by the one or more processors, cause the one or more processors to perform operations. The operations may include monitoring whether an obstruction is present in the area based on input from the one or more perception sensors. The operations may include, if the obstruction is determined to be present in the area, preventing, stopping, or reversing operation of the height adjustment device.

The one or more perception sensors may include a camera sensor.

The one or more perception sensors may include a LiDAR sensor.

The one or more perception sensors may include a ToF sensor.

The one or more perception sensors may include one or more of a RADAR sensor, a EmDAR sensor, a SONAR sensor, a SODAR sensor, a GNSS sensor, an accelerometer sensor, a gyroscope sensor, an IMU sensor, an infrared sensor, a laser rangefinder sensor, an ultrasonic sensor, an infrasonic sensor, and a microphone.

The area may be disposed underneath a high voltage battery assembly of the vehicle.

The area may approximately correspond to a perimeter of the high voltage battery assembly.

The operations may include, if an obstruction is determined to be present in the area, triggering at least one of a visual and an audible alert.

The operations may include, if an obstruction is determined to be present in the area, providing feedback including a status information associated with the height adjustment device.

The operations may include, if an obstruction is determined to be present in the area, providing feedback including data associated with the one or more perception sensors.

The operations may include identifying a location of a pick-up/drop-off location based on the input from the one or more perception sensors. The operations may include determining if the high voltage battery assembly is aligned with the pick-up/drop-off location based on the input from the one or more perception sensors.

The operations may include providing control signals to adjust the position of the vehicle so that the obstruction is outside of the area.

The operations may include updating a map including a pick-up/drop-off location based on the detection of the obstruction in the safety zone.

The system may be installed in the vehicle.

The vehicle may be an autonomous vehicle.

The vehicle may be a wheelchair accessible vehicle having a vehicle access device.

The vehicle may be one of the previously mentioned battery electric vehicles or result from performing one of the previously mentioned methods for modifying such a vehicle.

In another embodiment, a method may be provided for modifying a battery electric vehicle from an OEM condition into a modified condition. In the OEM condition, the battery electric vehicle may have an original high voltage battery assembly with at least one of an original ground clearance and an original ramp over angle when the battery electric vehicle is at an OEM GVWR. The method may include installing a high voltage battery assembly at a lower elevation than the original high voltage battery assembly relative to a body of the battery electric vehicle. The method may also include reducing the OEM GVWR to a modified GVWR. At the modified GVWR the high voltage battery assembly has at least one of a modified ground clearance and a modified ramp over angle, and at least one of: (1) the modified ground clearance is slightly less than, approximately equal to, or greater than the original ground clearance; and (2) the modified ramp over angle is slightly less than, approximately equal to, or greater than the original ramp over angle. The method may also include the step of operating the battery electric vehicle at a weight or only at a weight less than the modified GVWR. The method may also include the step of labeling the battery electric vehicle with the modified GVWR, e.g., modifying an existing safety compliance certification label or applying a new safety compliance certification on the battery electric vehicle that reflects the modified GVWR. The method may also include any of the vehicle modification steps recited above.

In another embodiment, a method for modifying a battery electric vehicle from an OEM condition into a modified condition may be provided. In the OEM condition the battery electric vehicle may have an original high voltage battery assembly with at least one of an original ground clearance and an original ramp over angle when at least one axle of the battery electric vehicle is at an OEM GAWR. The method may include installing a high voltage battery assembly at a lower elevation than the original high voltage battery assembly relative to a body of the battery electric vehicle. The method may also include reducing the OEM GAWR to a modified GAWR. At the modified GAWR the high voltage battery assembly has at least one of a modified ground clearance and a modified ramp over angle, and at least one of: (1) the modified ground clearance is slightly less than, approximately equal to, or greater than the original ground clearance; and (2) the modified ramp over angle is slightly less than, approximately equal to, or greater than the original ramp over angle. The method may also include the step of operating the battery electric vehicle at a weight or only at a weight less than the modified GAWR. The method may also include the step of labeling the battery electric vehicle with the modified GAWR, e.g., modifying an existing safety compliance certification label or applying a new safety compliance certification on the battery electric vehicle that reflects the modified GAWR. The method may also include any of the vehicle modification steps recited above.

### BRIEF DESCRIPTION OF DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

Corresponding reference numerals are used to indicate corresponding parts throughout the several views.

FIG. 1 is a side view of an example embodiment of a stock (OEM) battery electric vehicle in the form of a full-size van.

FIG. 2 is a rear view of the example embodiment of the stock battery electric vehicle.

FIG. 3 is a cross-sectional view of a floor structure for the example embodiment of the stock battery electric vehicle.

FIG. 4 is a side view of a first example embodiment of a modified battery electric vehicle.

FIG. 5 is a cross-sectional view of a modified floor structure for the first example embodiment of the modified battery electric vehicle.

FIG. 6 is a first side view of a second example embodiment of a modified battery electric vehicle.

FIG. 7 is a rear view of the second example embodiment of the modified battery electric vehicle.

FIG. 8 is a second side view of the second example embodiment of the modified battery electric vehicle.

It should be understood that the drawings are not necessarily to scale and that the embodiments are sometimes illustrated by graphic symbols, phantom lines, diagrammatic representations and fragmentary views. In certain instances, details which are not necessary for an understanding of the embodiments described and claimed herein or which render other details difficult to perceive may have been omitted. It should be understood, of course, that the inventions described herein are not necessarily limited to the particular embodiments illustrated. Indeed, it is expected that persons of ordinary skill in the art may devise a number of alternative configurations that are similar and equivalent to the embodiments shown and described herein without departing from the spirit and scope of the claims.

### DETAILED DESCRIPTION OF THE EMBODIMENTS

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure. Any alterations and further modifications in the described embodiments and any further applications of the principles of the inventions as described herein are contemplated as would normally occur to one skilled in the art. Although a limited number of embodiments are shown and described, it will be apparent to those skilled in the art that some features that are not relevant to the claimed inventions may not be shown for the sake of clarity.

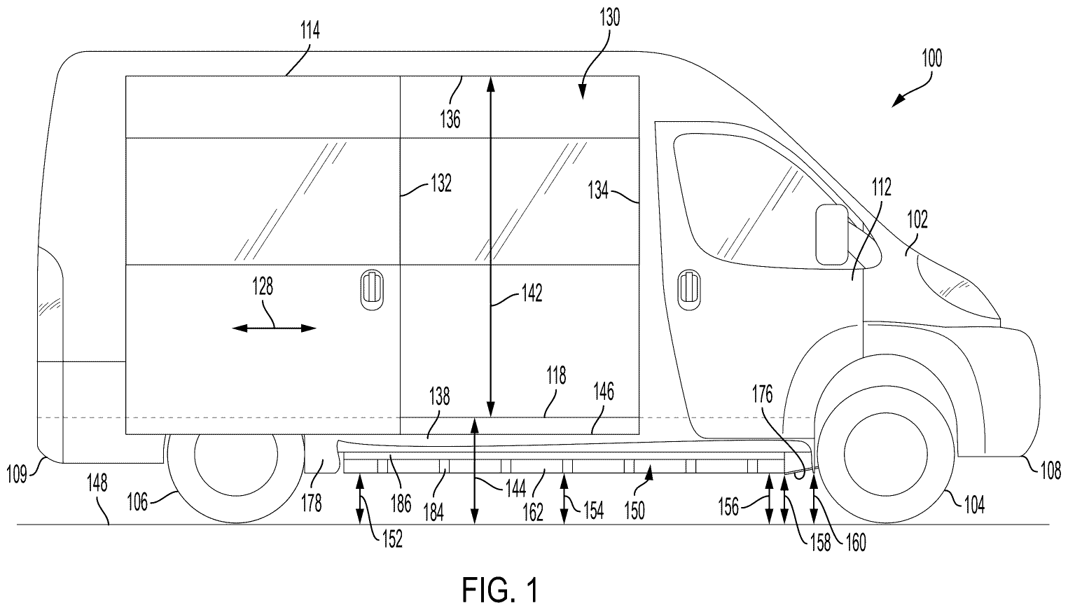

FIGS. 1-3 illustrate an example embodiment of a stock BEV 100, in particular a full-size van available or soon to be available from several United States and foreign original equipment manufacturers (OEMs), such as a Ram ProMaster EV or a Ford E-Transit. The BEV 100 comprises a unibody construction. However, other vehicles contemplated within this disclosure may include a frame on body construction or other constructions. Additionally, vehicle types other than full-size vans are contemplated within this disclosure, including but not limited to minivans and SUVs.

The BEV 100 includes a vehicle body or chassis 102 operatively coupled to front wheels 104 and rear wheels 106 which support the BEV 100 as it traverses the ground. The front wheels 104 define a front axle and the rear wheels 106 define a rear axle of the BEV 100.

The BEV 100 includes a front end 108 and a rear end 109. A conventional driver's seat and front passenger seat (not shown) are generally located towards the front end 108 of the BEV 100, whereas a plurality of rear passenger seats (not shown) are generally located towards the rear end 109 of the vehicle. More specifically, the BEV 100 includes an interior that comprises a front interior portion, where the driver's seat and front passenger seat are located, and a rear interior portion. In some embodiments, multiple rows of rear seats are located in the rear interior portion of the BEV 100. In other embodiments, the rear interior portion of the BEV is configured to carry cargo and has less or no seats.

The BEV 100 includes a first or front passenger side door 112 located between the front wheels 104 and rear wheels 106 and providing access to a passenger for sitting in a front passenger seat (not shown) of the BEV 100 adjacent to the driver. In this position, the passenger has a clear forward view of the road when compared to sitting in a rear passenger seat of the BEV 100. Moreover, when seated, the passenger is facing in a forward direction of travel. Further, coupled to the frame 102, the BEV 100 includes a second or rear passenger side door 114 between the front and rear wheels 104, 106 and one or more rear doors 115 located at the rear end of the vehicle. It is contemplated that other vehicles within the scope of this disclosure may have a different number and/or different locations of doors.

Any one or more of the doors 112, 114, 115 may be hingedly or slidably coupled to the frame 102 of the BEV 100. In this embodiment, doors 112, and 115 are hingedly coupled while the second door 114 is slidably coupled to the frame 102. In any case, door operation may be motorized to automatically move the doors 112, 114, 115 between an open position and a closed position. See, for example, U.S. Provisional Patent Application No. 63/491,552, filed on Mar. 22, 2023, which is incorporated herein by reference. In FIG. 1, the second door 114 is capable of being moved along a direction indicated by arrow 128 between an open position and a closed position. A user may grasp and manipulate a door handle to manually move the door 114 between the open and closed positions. In further embodiments, a key fob, vehicle switch, and/or other electrical control device (not shown) may send an electrical signal to a controller for a motor that moves the door 114 between its open and closed positions.

As the door 114 is moved to the open position, an opening 130 is created to provide access to the interior of the BEV 100. The opening 130 may be defined on the sides thereof by an edge 132 of a B-pillar and the edge 134 of the C-pillar (or alternatively an edge of the door 114). The opening 130 may additionally be defined at the top by an edge 136 adjacent to the roofline and at the bottom by edge 138 adjacent the bottom surface of the BEV 100. The usable height 142 of the vehicle opening 130 may be defined as the distance between the top edge 136 of the vehicle opening and floor surface 118 of the BEV 100. The step-in height 144 of the BEV 100 may be defined as the distance between the ground 148 and the floor surface 118, which may include a carpet. Some BEVs 100 with a large step-in height 144 may include an internal step 146 disposed between the floor surface 118 and the bottom edge 138 or an external step disposed below the edge 138 to assist entry by amble passengers.

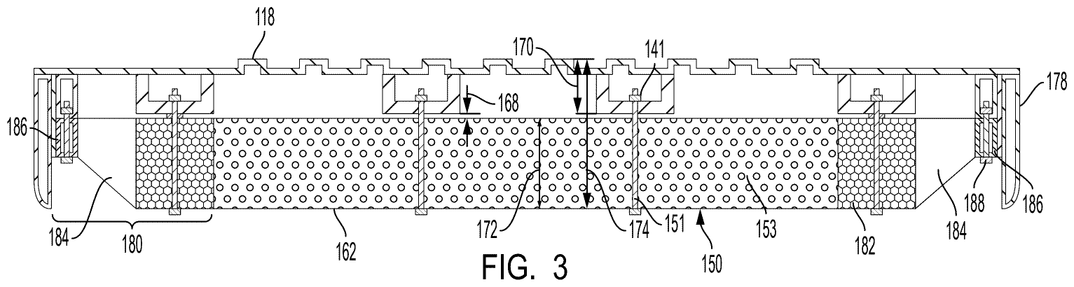

The BEV 100 includes a high capacity, high voltage (HV) battery assembly 150 (for example, in the case of the Ford E-Transit, a 68.0 kWh, 450 VDC battery) connected to the underside of the vehicle. The HV battery assembly 150 comprises a plurality of battery cells 153 disposed within a housing 162 or protective shell. With particular reference to FIG. 3, the HV battery assembly 150 is connected to the floor structure 140 of the BEV 100 using a plurality of bolts 151. The bolts connect to corresponding fasteners 141 that are integrated with the floor structure 140. In the installed position, an air gap with thickness 168 exists between the upper plane of the HV battery housing 162 and the underside of the floor structure 140. Additionally, floor structure 140 has a thickness 170, while the HV battery assembly 150 has a thickness 172. The total floor thickness 174 is therefore defined by the thickness 170 of the floor structure 140, the thickness 168 of the air gap, and the thickness 172 of the HV battery assembly 150.

The HV battery assembly 150 may include or accompany a “crush zone” or energy absorption structures to protect the battery. The “crush zone” may include a combination of one or more structural members that may be located inside and/or outside of the housing for the HV battery assembly 150. In some embodiments, the “crush zone” may be integral to the HV battery assembly 150, for example a honeycomb structure integrated into the housing. In other embodiments, the “crush zone” may be attached (permanently or removably) to the outside perimeter of HV battery assembly 150, for example, crush “cans” glued or welded to the housing of the HV battery assembly, or a cage fastened to the HV battery assembly by bolts. In yet other embodiments, the “crush zone” may be a portion of the BEV 100, for example, a rocker panel. In even further embodiments, a combination of any of the previously mentioned structures may be used.

With particular reference to FIG. 3, one example BEV 100 includes a crush zone 180 on the left and right sides of the HV battery assembly 150 to protect the HV battery cells 153 from a side impact. On each side, the crush zone 180 comprises a honeycomb core 182, a plurality of crush members or cans 184, a longitudinal beam 186, and at least a portion of the vehicle rocker panel 178. The honeycomb core 182 is disposed inside of and at the perimeter the housing of the HV battery assembly 150. The plurality of crush cans 184 are permanently affixed (e.g., welded, glued, etc.) at their proximal end to the side of the housing of the HV battery assembly 150 in spaced apart relation along a longitudinal axis. The crush cans extend laterally outward therefrom and are permanently affixed (e.g., welded, glued, etc.) at their distal end to the longitudinal beam 186. The longitudinal beam 186 may be defined as a structural tube member and extends longitudinally along at least a portion of the length of the HV battery assembly 150. At least a portion of the rocker panel 178 extends downward from the floor surface 118 and is positioned on both the right and left side of the HV battery assembly 150 to protect it from side impacts. More particularly, at least a portion of the rocker panel 178 extends below the upper plane of the HV battery assembly 150 and outside of the longitudinal beam 186 and crush cans 184. To provide the crush zone 180 with additional integrity or rigidity, the longitudinal beam 186 may be secured to the rocker panel 178 via a plurality of bolts 188 or other fasteners.

In some embodiments, the front and rear edges may include similar crush zones as the left and right sides. However, because the front and rear edges of the HV battery assembly 150 are at roughly the same elevation as the front and rear axles, the front and rear axles may protect the front and rear edges of the HV battery assembly 150 from road debris. Similarly, the crush zones integrated into the vehicle chassis 102 both forward and rearward of the front and rear axles provide the HV battery assembly 150 with protection from front and rear collisions. Accordingly, the OEM BEV 100 may not need or include any external, supplemental structural members for protecting the front edge of the HV battery assembly 150. However, the BEV 100 includes a lightweight shield 176 that is not considered herein to be a structural member. The shield 176 merely prevents light weight road debris from blowing up and getting caught between the front axle and the front edge of the HV battery housing 162. The shield 176 is defined by a thin gauge plate aligned in a roughly horizontal plane at least partially below the lower plane of the HV battery housing and generally extending between the front edge of the HV battery housing 162 and the front axle.

With particular reference to FIG. 1, the ground clearance 152, 154, 156, 158, 160 of the BEV 100 may be defined as the distance between the ground 148 and a reference underside/lower surface of the BEV 100. Ground clearance 152 is the distance between a rear end of the HV battery assembly 150 and the ground 148. Ground clearance 154 is the distance between a middle of the HV battery assembly 150 and the ground 148. Ground clearance 156 is the distance between a front end of the HV battery assembly 150 and the ground 148. Ground clearance 158 is the distance between the battery shield 176 and the ground 148. Ground clearance 160 is the distance between a rocker panel 178 and the ground 148.

In one example OEM BEV 100, the floor thickness 170 may be approximately 4.4″, the air gap thickness 168 may be approximately 0.75″, and the battery thickness 172 may be approximately 7″, for a total thickness 174 of approximately 12.15″. With the OEM BEV 100 at curb weight, rear-end ground clearance 152 may be approximately 10.9″, mid-point ground clearance 154 may be approximately 10.0″, front-end ground clearance 156 may be 9.2″, battery shield ground clearance 158 may be 8.8″, rocker clearance 160 may be 11.9″, and step-in height 144 may be 21.4″. With the BEV at GVWR (gross vehicle weight rating), rear-end ground clearance 152 may be approximately 8.6″, mid-point ground clearance 154 may be approximately 8.3″, front-end ground clearance 156 may be 8.0″, battery shield ground clearance 158 may be 7.2″, rocker clearance 160 may be 10.7″, and step-in height 144 may be 20.2″. Notably, the usable height 142 of the OEM vehicle opening 130 is approximately 68″.

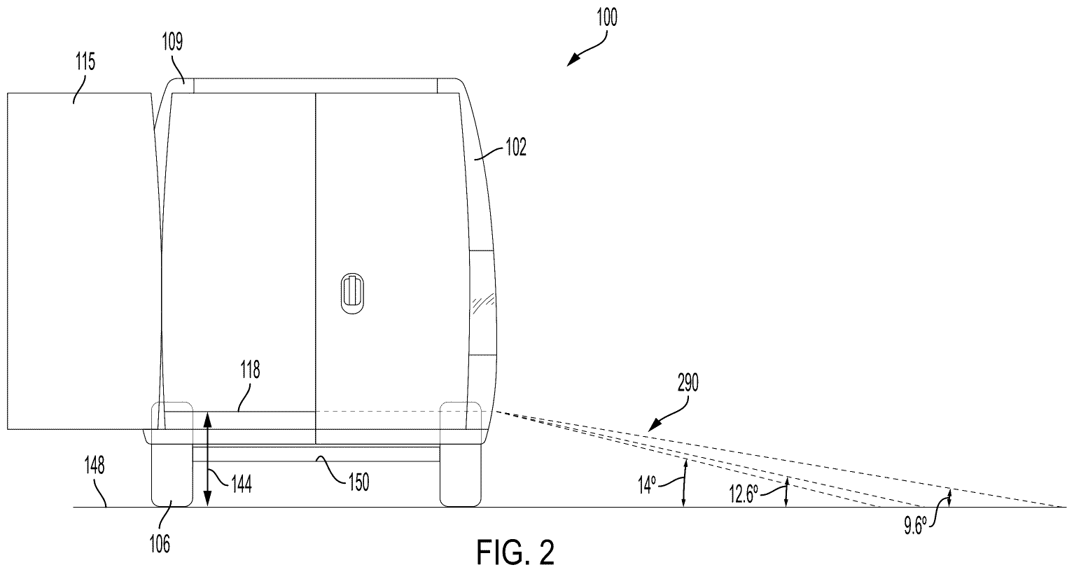

Clearly, the example OEM BEV 100 as configured is not suitable and/or practical for use with a ramp 290. With particular reference to FIG. 2 and an OEM BEV 100 at curb weight, a ramp 290 extending between the vehicle floor surface 118 and the ground 148 at a steep angle of 14° (slightly less than ADA maximum slope of 1:4) would have a length of approximately 71.9″—approximately 6 feet long. If the ramp were angled at 12.6°, which is better but not optimal, the ramp 290 would have a length of approximately 79.8″—nearly 7 feet long. At a more optimal angle of 9.6°, which would provide a higher comfort level for a wheelchair passenger, the ramp 290 would have a length of approximately 104.3″—nearly 9 feet long. Any of these ramps 290 would be too long or not practical for use with a standard accessible parking space, which typically has a cross-hatched access aisle with a width of only 8 feet wide. Even at 14°, the ramp would provide only 2 feet of clearance with an adjacently parked vehicle—too little for a wheelchair passenger to comfortably or easily maneuver on and off the ramp.

Although it is known in the art to lower the floors of ICE vehicles, BEVs 100 have not previously been considered viable candidates for lowered-floor modification. As discussed above, the HV battery assembly 150 is one of the most expensive subsystems of the BEV 100 and is sensitive to damage. HV battery assemblies 150 typically cannot be repaired and usually must be replaced if damaged. While lowering the vertical height of the HV battery assembly 150 from its original OEM position in a mobility conversion has many ingress/egress advantages for mobility conversions and users, i.e., a lowered floor allowing more comfortable ramp angles, lowering the HV battery assembly 150 would make it more susceptible to damage from road debris and if the vehicle were to bottom out, drive over a speed bump, etc. and more susceptible to damage from side-impact collisions.

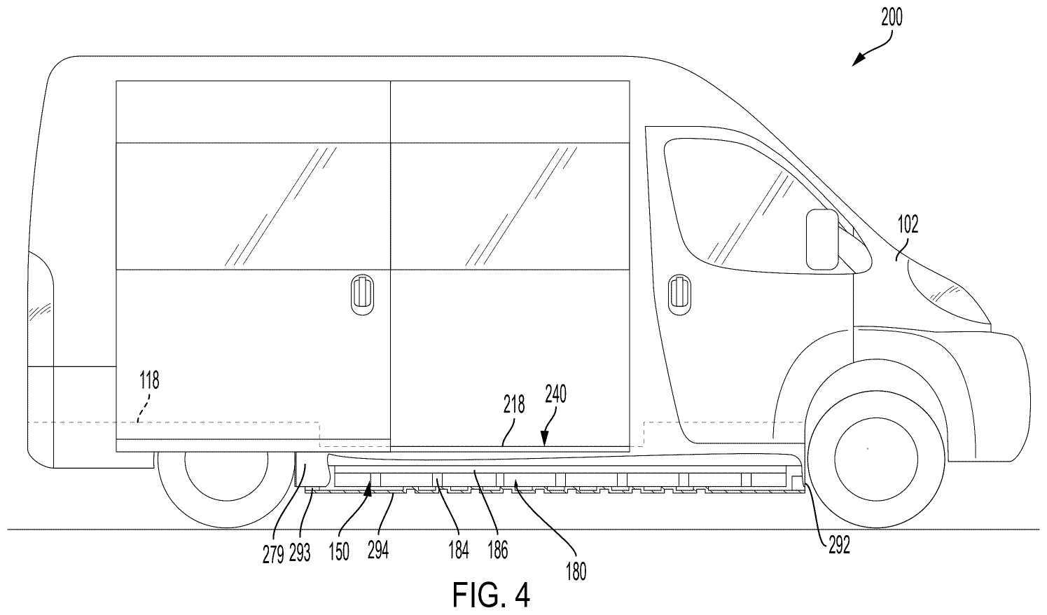

Accordingly, it is contemplated in some embodiments that a relocated HV battery assembly 150 could preserve, at least to some extent, OEM “crush zones” 180. It is also contemplated in some embodiments that additional “crush zone” 180 structures may be added to protect against new hazards introduced by relocating the HV battery assembly 150. For example, in one embodiment of a modified BEV 200 depicted in FIG. 4, the BEV 100 of FIGS. 1-3 has been modified to replace a large portion of the floor 140 with a lowered floor 240 that holds the HV battery assembly 150, along with at least one of the “crush zone” 180 structures, at a lower elevation relative to the chassis 102. The lowered floor 240 includes a floor surface 218 that is at a lower elevation than the OEM floor surface 118 relative to the chassis, to permit more desirable ramp angles. The lowered floor 240 may have a thinner vertical profile as compared to the OEM floor 140. Additionally, the lowered floor surface 218 may be flat, for wheelchair maneuverability, and may be upfit with accessibility equipment such as tie down systems, docks, belting, etc. to accommodate wheelchairs and those with mobility disabilities.

The lowered floor 240 may be a “floor weldment” known in the art that is welded in place of the portion of the original floor 140 that is cut out and discarded. The lowered floor 240 may include or be configured to engage with fasteners 241 arranged in the same pattern as the fasteners 141 of the OEM floor 140, whereby the OEM bolts 151 (or replacement bolts) may be used to secure the HV battery assembly 150 in the lowered position. Any “crush zone” components integral/permanently attached to the assembly 150, such as the honeycomb core 182, cans 184, and longitudinal beam 186 of BEV 100 of FIGS. 1-3, may be moved with and share the lowered position of the HV battery assembly. In other embodiments, any of the permanently attached structures, such as cans 184 and longitudinal beam 186 can be cut off and removed. Any removable crush zone 180 structures, such as a bolted-on cage for example, could be installed in the lowered position with the HV battery assembly 150 or could be discarded. The portion of the vehicle rocker panel 178 that sits adjacent the HV battery assembly 150 in its OEM position could be cut off and lowered, or a new rocker panel extension 279 could be installed with a bolting pattern that matches that on the longitudinal beam 186 for engagement with bolts 188. It is contemplated that rocker panel extension 279 would provide additional protection for the HV battery assembly 150, e.g., crush zone properties to absorb the energy from a side impact. Notably, in other embodiments, the rocker panel extension 279 may include and take the form of a “running board” (not shown) that provides a step for non-disabled passengers to enter the vehicle. In yet other embodiments, a separate running board at an elevation that overlaps with and provides additional protection for the HV battery assembly 150 may be added to BEV 200.

In its lowered position, at least a portion of the front edge of the HV battery assembly 150 could sit below the front axle and be susceptible to road debris. While the lightweight shield 176 could be reinstalled as shown, the thin gauge nature of that shield 176 may not provide adequate protection. Accordingly, it is contemplated that a front impact structure, bumper or sacrificial member 292, such as a “cow catcher” or other deflection device, could be installed forward of the HV battery assembly 150. The front impact structure 292 could be a rigid bar or could be designed to yield or crush to absorb energy. In either case, the front impact structure 292, or a portion thereof, could be oriented at an angle relative to the lateral axis of the vehicle to redirect any road debris to the sides of the vehicle. Ideally, the front impact structure 292 is positioned between the front axle and the front of the HV battery assembly. However, it is contemplated that the configuration of some vehicles may necessitate moving the front impact structure 292 forward of the front axle. A similar rear impact structure (or bumper) 293 may be provided rearward of the HV battery assembly 150 (either forward or rearward of the rear axle).

Lowering the HV battery assembly 150 will also reduce the ramp-over angle of the BEV 200. Accordingly, an underside-impact bumper, structure or sacrificial member 294, such as a “bash plate” could be installed on the BEV 200 underneath the HV battery assembly 150. As with the structure 292, underside-impact structure 294 could be one or more rigid bars, cages, or plates (to lift vehicle over road debris) or could be designed to yield or crush to absorb energy.

Any of the previously mentioned bumpers or other supplemental structures for protecting the HV battery assembly, e.g., rocker panel extension 279, structures 292, 294, could be directly or indirectly mounted to the chassis 102 of the BEV whereby any impact loads bypass the HV battery assembly 150.

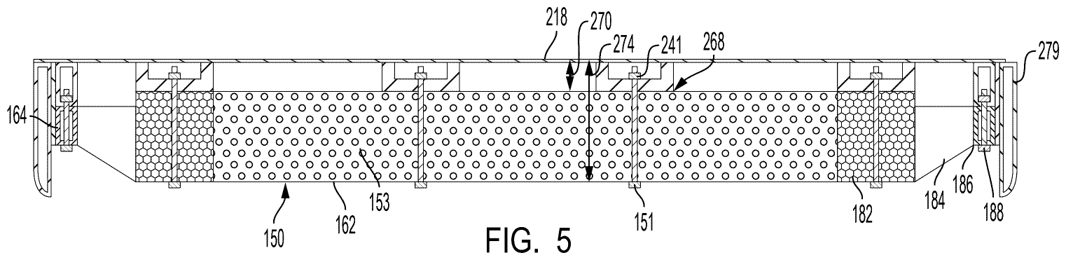

In modifying BEV 100 to be a modified wheelchair accessible vehicle 200, it is also contemplated in some embodiments that the OEM configuration (e.g., ground clearance) of the HV battery assembly 150 should be preserved or recouped to the extent possible. For instance, as shown in FIG. 5, the total floor thickness 274 of the modified floor 240 could be reduced as compared to the total floor thickness 174 of the OEM floor 140, so that the floor surface 218 drops further than the HV battery assembly 150 drops. More particularly, one or both of the floor thickness 270 and air gap 268 can be reduced as compared to OEM floor thickness 170 and air gap 168, whereby the drop distance of the modified floor surface 218 relative to the OEM floor surface 118 will be greater than the drop distance of the HV battery assembly 150 on the modified BEV 200 relative to its OEM position on the OEM BEV 100. In some embodiments, the floor thickness 270 can be thinner than the OEM floor thickness 170 by approximately 2″ or more. In other embodiments, the air gap 268 can be thinner than the OEM air gap 268 by approximately 0.25″ or more. In yet other embodiments, the total floor thickness 274 can be thinner than the OEM total floor thickness 174 by approximately 1″, 1.75″, 2″ or more.

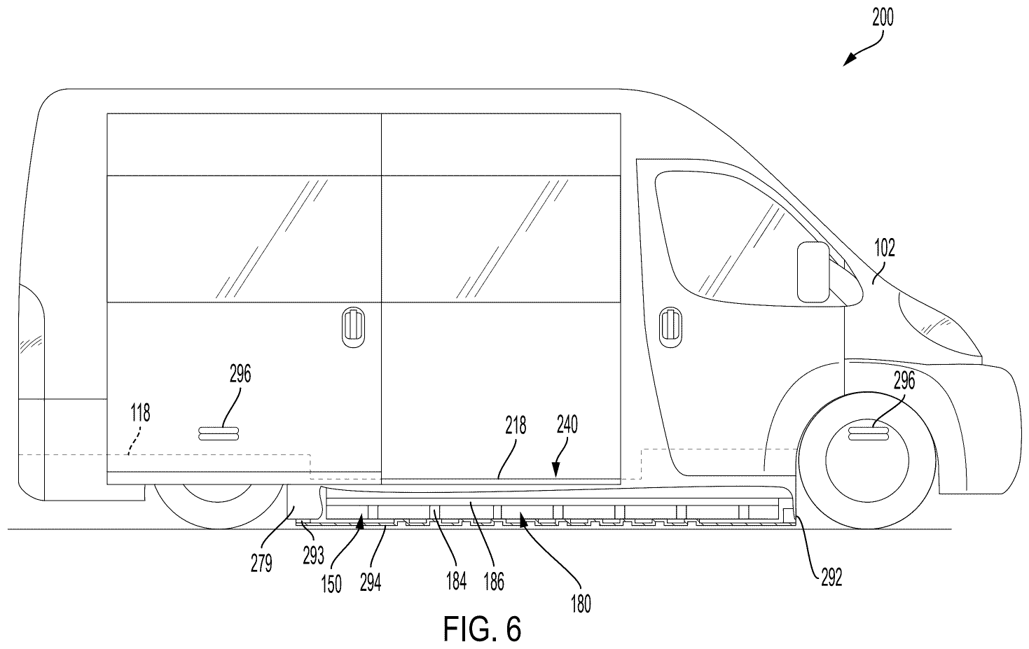

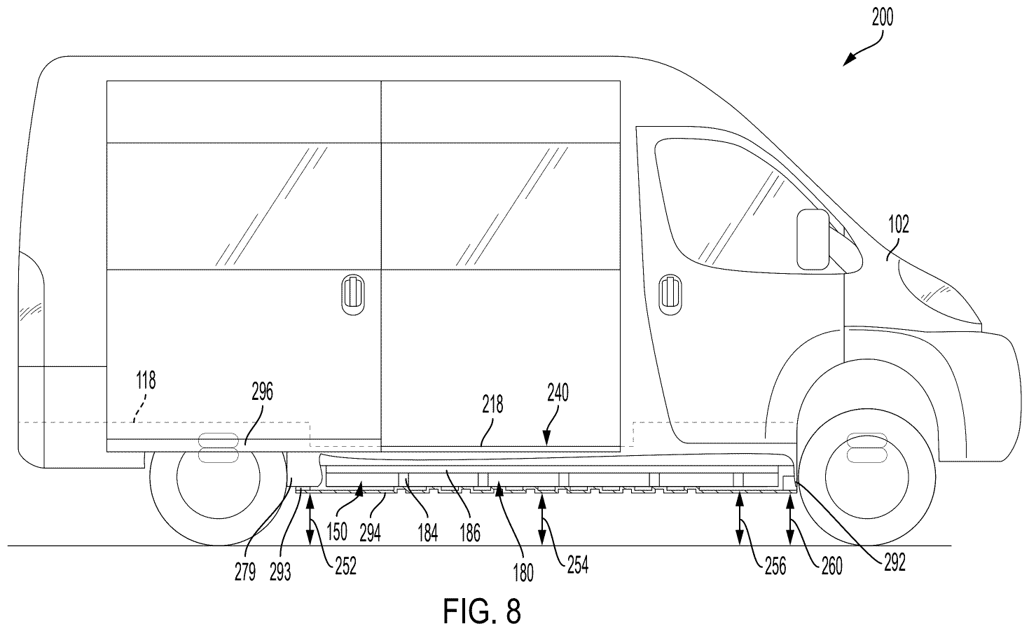

As yet another example shown in FIGS. 6-8, the suspension at any one or more wheels of the OEM BEV 100 could be replaced or supplemented with an air suspension, airbag or other kneeling/lifting device 296 whereby the elevation of the modified BEV 200 chassis 102 can be raised and lowered on command, for example by operation of an on-vehicle air compressor and release valve in fluid communication therewith. Ingress and egress can be enhanced beyond structurally lowering the floor step-in height by kneeling the vehicle suspension. Kneeling is the act of lowering the vehicle suspension, thus lowering the floor step-in height, resulting in both lower step-in height and lower ramp angles, both advantageous to the disabled spectrum. Most common are mechanisms that compress the OEM suspension or suspension systems that can be actively controlled. In one embodiment, the kneeling/lifting device can move the modified BEV 200 chassis 102 between a kneeled position and a lifted position, the lifted position being at a higher elevation than the kneeled position. In some embodiments, the difference in elevation of the BEV 200 chassis 102 between the kneeled and lifted positions can be approximately 3″, 4″, 5″, 6″ or more.

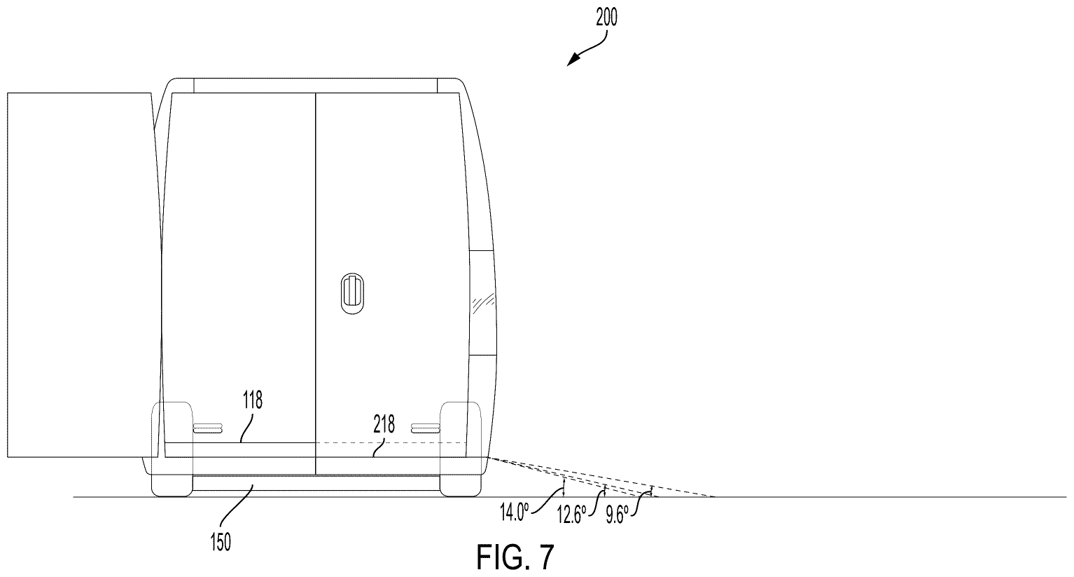

In the kneeled position, the floor 218 is closer to the ground 148 which allows a more palatable ramp 290 angle and length. For example, with reference to FIG. 7, it is anticipated that the modified BEV 200 at both curb weight and GVWR may have a step in height 244 of 13.8″ or less, whereby a ramp 290 extending between the vehicle floor surface 218 and the ground 148 could have a length of 57.2″ or less at an angle of 14° (slightly less than ADA maximum slope of 1:4), 63.4″ or less at an angle of 12.6°, and 83″ or less at an angle of 9.6°. In some embodiments, the HV battery assembly 150 or underside-impact structure 294 can be touching or nearly touching the ground 148 when the BEV 200 is in the kneeled position to reduce the step-in height 244 to an improved, optimized, or maximum extent.

In the lifted position, the ground clearance for the HV battery assembly 150 is increased to reduce the possibility of ground contact or damage from road debris while the modified BEV 200 is driving. The use of some types of kneeling/lifting devices 296, such as airbags or other kneeling devices, allows the modified BEV 200 chassis 102 to stay at a relatively constant elevation in the lifted position regardless of the loading condition. In that regard, the elevation of the modified BEV 200 chassis 102 at the lifted position is roughly the same when the BEV 200 is at curb weight and GVWR. In some embodiments, in the lifted position, at least one of the ground clearances 252, 254, 256, 260 for the HV battery assembly 150 of the modified BEV 200 is slightly less than, approximately equal to or greater than the corresponding ground clearance 152, 154, 156, 160 for the HV battery assembly 150 of the OEM BEV 100 at GVWR. If present on the modified BEV 200, the ground clearance for the shield 176 may be slightly less than, approximately equal to or greater than the corresponding ground clearance 158. Maintaining the ground clearance of the HV battery assembly 150 in the modified BEV 200 above the minimum ground clearance deemed acceptable by the OEM (i.e., the ground clearance of OEM BEV 100 at GVWR) should preserve the OEM warranty over the HV battery assembly 150 for the end user. In alternative embodiments, in the lifted position, the BEV 200 can have a ramp over angle that is slightly less than, approximately equal to or greater than the ramp over angle of the BEV 100 at GVWR.

In an alternative embodiment, the BEV 200 may be equipped with an air compressor and release valve that fluidly communicate with the vehicle tires to act as the kneeling/lifting device (deflating the tires to move the chassis 102 to the kneeled position and inflating the tires to move the chassis 102 to the lifted position). The tire inflation/deflation device can be used alone or in combination with the previous kneeling suspension embodiments.

In some embodiments, the modified BEV 200 may be equipped with a controller for the kneeling/lifting device 296 to move the modified BEV 200 between the kneeled position (ingress/egress position) and the lifted position (driving position) and maintaining the BEV 200 at a relatively constant elevation during transit. The modified BEV 200 could also be provided with perception sensors for detecting objects/obstructions located under the HV battery assembly 150 to ensure the area below the HV battery assembly 150 is clear before proceeding to kneel the BEV 200. The perception sensor may be a camera sensor system or a Light Detection and Ranging (LIDAR) sensor system. Other acceptable sensor systems include radio detection and ranging (RADAR) sensor systems, Electromagnetic Detection and Ranging (EmDAR) sensor systems, Sound Navigation and Ranging (SONAR) sensor systems, Sound Detection and Ranging (SODAR) sensor systems, Global Navigation Satellite System (GNSS) receiver systems such as Global Positioning System (GPS) receiver systems, accelerometers, gyroscopes, inertial measurement units (IMU), infrared sensor systems, laser rangefinder systems, ultrasonic sensor systems, infrasonic sensor systems, microphones, or a combination thereof. It is contemplated that any number or combination of sensors may be used as the perception sensor. The controller for operating the kneeling/lifting device 296 may comprise one or more conventional computing system or other capable computing device or board that is programmed to prevent kneeling of the modified BEV 200 when an obstruction is sensed to be present below the HV battery assembly 150 (a fault condition), and/or to notify an occupant of operator of the vehicle of the fault condition via audible, visible, or tactile alerts. In an autonomous modified BEV 200, the computing system may also be programmed to move the vehicle to a location that lacks an obstruction or to prevent the vehicle from stopping at an ingress/egress location where such an obstruction is present. The computing system may also be configured to update or modify vehicle maps to eliminate locations where obstructions are present as acceptable ingress/egress locations or to add locations where obstructions are absent as acceptable ingress/egress locations. An example autonomous vehicle environment in which this obstruction perception system and fault alert system could operate is described in U.S. Patent Application No. 63/484,000, filed 9 Feb. 2023, which is incorporated herein by reference.

In yet additional alternative embodiments, the GVWR and/or GAWR (front and/or rear axle) in a BEV with a lowered HV battery assembly may be reduced as compared to the OEM GVWR and/or GAWR. With the modified BEV loaded to the reduced GVWR and/or GAWR, the lowered HV battery assembly of the modified BEV may have: (a) a ground clearance that is slightly less than, approximately equal to, or greater than the original ground clearance of the OEM vehicle at the OEM GVWR and/or GAWR; and/or (b) a modified ramp over angle that is slightly less than, approximately equal to, or greater than the original ramp over angle of the OEM vehicle at the OEM GVWR and/or GAWR. In addition to reducing the GVWR and/or GAWR, the modified BEV may incorporate any of the previously mentioned modifications and/or methods of modification. For instance, the BEV may also incorporate a height adjustment device to move at least a portion of the body of the battery electric vehicle between a lowered position and a raised position. With the modified BEV in the raised position and loaded to the reduced GVWR and/or GAWR, the lowered HV battery assembly of the modified BEV may have: (a) a ground clearance that is slightly less than, approximately equal to, or greater than the original ground clearance of the OEM vehicle at the OEM GVWR and/or GAWR; and/or (b) a modified ramp over angle that is slightly less than, approximately equal to, or greater than the original ramp over angle of the OEM vehicle at the OEM GVWR and/or GAWR.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A method for modifying a battery electric vehicle from an OEM condition into a modified condition, wherein in the OEM condition the battery electric vehicle has an original high voltage battery assembly with an original ground clearance, the method comprising the steps of:
installing a high voltage battery assembly at a lower elevation than the original high voltage battery assembly relative to a body of the battery electric vehicle; and
configuring a height adjustment device to move at least a portion of the body of the battery electric vehicle between a lowered position and a raised position, wherein in the raised position the high voltage battery assembly has a modified ground clearance that is approximately equal to or greater than the original ground clearance.

2. The method of claim 1, wherein the original ground clearance is defined when the battery electric vehicle is at an original GVWR.

3. The method of claim 2, wherein the original ground clearance is defined by a distance between a lower plane of the original high voltage battery assembly and a ground and the modified ground clearance is defined by a distance between a lower plane of the modified high voltage battery assembly and the ground.

4. The method of claim 3 wherein the height adjustment device comprises an airbag that is inflated to move the vehicle to the raised position and deflated to move the vehicle to the lowered position.

5. The method of claim 4 wherein in the lowered position an underside of the battery electric vehicle touches or approximately touches a ground.

6. The method of claim 4 further comprising the step of providing a ramp platform moveable between a stowed position and a deployed position, wherein in the deployed position the ramp bridges a gap between a floor surface of the battery electric vehicle and a ground.

7. The method of claim 6, wherein the ramp platform has a slope equal to or less than approximately 1:4 when the body of the battery electric vehicle is in the lowered position.

8. The method of claim 6 further comprising the step of lowering a floor of the battery electric vehicle relative to the body.

9. The method of claim 8, wherein the lowering the floor step involves removing at least a portion of an OEM floor structure and installing a modified floor structure.

10. The method of claim 9, wherein a thickness of the modified floor structure is less than a thickness of the OEM floor structure.

11. The method of claim 9, wherein in the OEM condition an original gap exists between the OEM floor structure and the original high voltage battery assembly and in the modified condition a thickness of a modified gap between the modified floor structure and the high voltage battery assembly is reduced relative to the original gap.

12. A battery electric vehicle comprising:
a high voltage battery assembly disposed below a vehicle floor, wherein in an OEM condition at an OEM GVWR the high voltage battery assembly has an original ground clearance;
a ramp platform moveable between a stowed position and a deployed position, wherein in the deployed position the ramp bridges a gap between a surface of the vehicle floor and a ground;
a height adjustment device configured move at least a portion of a body of the battery electric vehicle between a lowered position and a raised position wherein in the raised position the high voltage battery assembly has a ground clearance that is approximately equal to or greater than the original ground clearance.

13. The battery electric vehicle of claim 12, wherein the original ground clearance and the ground clearance are defined by the distance between a lower plane of the high voltage battery assembly and a ground.

14. The battery electric vehicle of claim 12, wherein the ramp platform has a slope equal to or less than approximately 1:4 when the body of the battery electric vehicle is in the lowered position.

15. The battery electric vehicle of claim 12 wherein the height adjustment device comprises an airbag that is inflated to move the vehicle to the raised position and deflated to move the vehicle to the lowered position.

16. The method of claim 12 wherein in the lowered position an underside of the battery electric vehicle touches or approximately touches a ground.

17. A method of operating the battery electric vehicle of claim 12, the method comprising:
at a first location, moving the battery electric vehicle to the lowered position, deploying the ramp whereby a wheelchair may enter the battery electric vehicle, stowing the ramp, moving the battery electric vehicle to the raised position; and
transporting the wheelchair to a second location.

18. The method of claim 17, further comprising the step of sensing whether an obstruction is present under the battery electric vehicle and preventing the battery electric vehicle from moving to the lowered position if an obstruction is present.

19. The method of claim 17, further comprising the step of sensing whether an obstruction is present under the battery electric vehicle and generating an alert if an obstruction is present.

20. The method of claims 19, further comprising the step of moving the vehicle to a different location if an obstruction is present.
